(19) United States
(12) Patent Application Publication
(10) Pub. No.: US 2003/0225728 A1
(43) Pub. Date: Dec. 4, 2003

(54) Pharmacy system and method

(76) Inventor: Anthony A. Moura, Newmarket (CA)

Correspondence Address: FRANCIS J. KOWALIK, ESQ., Corporate Counsel, Law Department, BAXTER INTERNATIONAL INC., One Baxter Parkway, DF3-2E, Deerfield, IL, 60015, US

(21) Appl. No.: 10/159,689

(22) Filed: May 31, 2002

(51) Int. Cl. G06F 7/00

(52) U.S. Cl. 707/1

(57) ABSTRACT

A system and method is disclosed for sharing information between an inpatient pharmacy system and an outpatient or retail pharmacy system. Generally, the system includes an inpatient pharmacy, having a workstation, and an outpatient pharmacy, also having a workstation. Operably connected to the workstations is a pharmacy database containing patient and customer information.

### RELATED APPLICATIONS

The present application claims priority from U.S. Patent Serial No. 60/377,027 filed Apr. 30, 2002; U.S. Patent Serial No. 60/376,625, filed Apr. 30, 2002; U.S. Patent Serial No. 60/376,655, filed Apr. 30, 2002; and U.S. patent Ser. No. 10/135,180 filed Apr. 30, 2002, which is a continuation-in-part of copending U.S. patent Ser. No. 10/059,929 filed Jan. 29, 2002, and incorporates such applications herein by reference.

Additionally, the present application is being filed concurrently with and incorporates by reference the following applications: “Automated Messaging Center System and Method For Use With A Healthcare System” (Attorney Docket No. EIS-5849 (1417G P 749)), Ser. No. ______; “System And Method For Obtaining Information From A Bar Code For Use With A Healthcare System” (Attorney Docket No. EIS-5897 (1417G P 754)), Ser. No. ______; “Infusion Therapy Bar Coding System and Method” (Attorney Docket No. EIS-5850 (01417GP0750)), Ser. No. ______; “System and Method for Providing Multiple Units of Measurement” (Attorney Docket No. EIS-5851(1417GP0751)), Ser. No. ______; “Nursing Order Workflow System and Method” (Attorney Docket No. EIS-5899(1417GP0756)), Ser. No. ______; “Healthcare Database Management Offline Backup and Synchronization System and Method” (Attorney Docket No. EIS-5895(1417G-P752)), Ser. No. ______; “Biometric Security For Access To A Storage Device For A Healthcare Facility” (Attorney Docket No. EIS-5847(1417G-P720)), Ser. No. ______; “System And Method For Supporting Clinical Decisions During Patient Care And Treatment” (Attorney Docket No. EIS-5896(1417G-P753)), Ser. No. ______; “System And Method For Facilitating Patient Care And Treatment” (Attorney Docket No. EIS-5898(1417G-P755)), Ser. No. ______; and, “System And Method For Facilitating Orders During Patient Care And Treatment” (Attorney Docket No. EIS-5900(1417G-P757)), Ser. No. ______.

### TECHNICAL FIELD

The present invention generally relates to pharmacy systems, and in particular, to a system for managing pharmacy data.

### BACKGROUND ART

Many inpatient healthcare facilities have in-house pharmacies with computer systems for maintaining records of all prescriptions ordered for patients while undergoing treatment. Likewise, many retail pharmacies have computer systems for keeping records of all customer prescription orders.

The records within the inpatient pharmacy database and the retail pharmacy database offer healthcare professionals a valuable source of information regarding a patient's medication history and current regimen. Presently, however, the records maintained by the inpatient pharmacy are not readily accessible to users of the retail pharmacy system. Likewise, the records maintained by the retail pharmacy system are not readily accessible to users of the inpatient pharmacy system.

Hence, a need exists for a system and method that provides accessability to both inpatient and outpatient pharmacy data.

### SUMMARY OF THE INVENTION

According to the present invention, a system and method has been developed that provides for the sharing of information between an inpatient pharmacy system and an outpatient or retail pharmacy system. The system can include an inpatient pharmacy having a workstation, and an outpatient pharmacy also having a workstation. Operably connected to the workstations is a pharmacy database containing patient and customer information.

Other advantages and features of the present invention will be apparent from the following description of a specific embodiment illustrated in the accompanying drawings.

### BRIEF DESCRIPTION OF DRAWINGS

FIG. 1 is a simplified schematic diagram of a system in accordance with the present invention having an inpatient pharmacy system and an outpatient pharmacy system that are linked together;

FIG. 2 is a simplified schematic diagram of another system in accordance with the present invention having an inpatient pharmacy system and an outpatient pharmacy system that are linked to a database;

FIG. 3 is an embodiment of a window displayed on workstations within the inpatient and outpatient pharmacy systems of FIGS. 1 and 2;

FIG. 4 is a simplified inverted tree structure block diagram depicting some of the data accessible from the window of FIG. 3; and,

FIG. 5 is a simplified flow diagram of a workflow process in accordance with the present invention.

### DETAILED DESCRIPTION

While this invention is susceptible of embodiments in many different forms, there is shown in the drawings and will herein be described in detail a preferred embodiment of the invention. The present disclosure is to be considered as an exemplification of the principles of the invention and is not intended to limit the broad aspect of the invention to the embodiment illustrated.

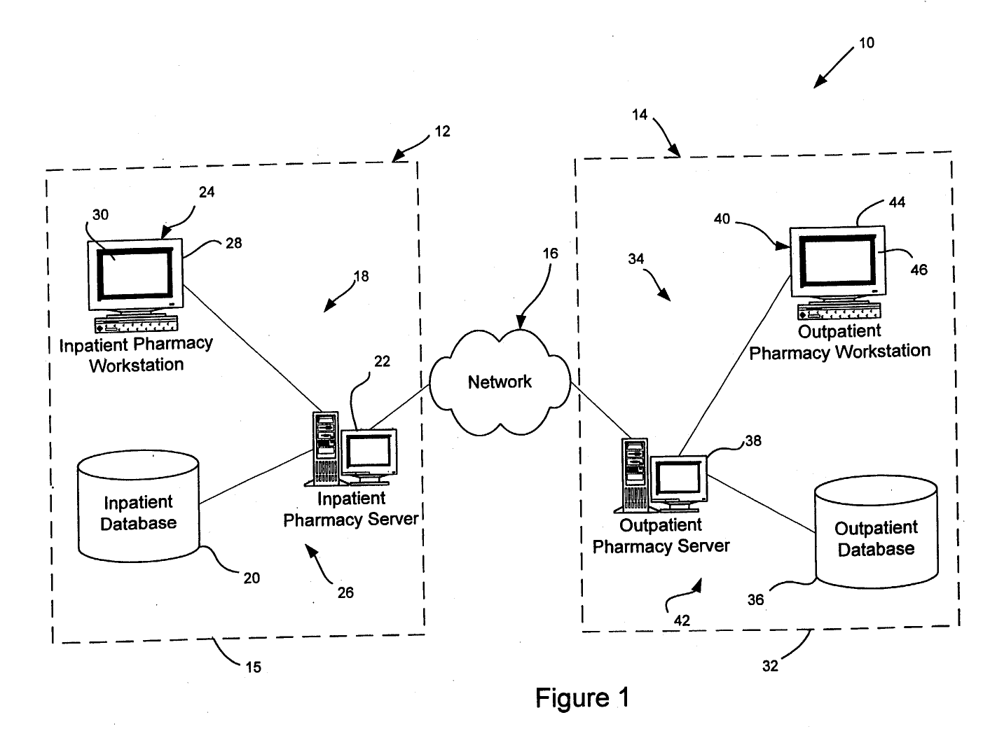

Referring now to the drawings, and particularly to FIG. 1, a simplified schematic diagram is provided of a system 10 in accordance with the present invention. In an embodiment, the system includes an inpatient pharmacy system 12 and an outpatient pharmacy system 14 in communication with each other over a network system 16.

The inpatient pharmacy system 12 provides for maintaining pharmacy data, including records of inpatients. In an embodiment, the inpatient pharmacy system 12 is resident, at least in part, within an inpatient healthcare facility 15. Such inpatient healthcare facilities include a long or short-term care institution that provides beds for people who need diagnostic, treatment or convalescent care services which require that they remain at least overnight and often for extended periods of time. Accordingly, inpatient healthcare facilities include hospitals or nursing homes.

The inpatient pharmacy system 12 has a plurality of resources 18 comprising a database 20, a server 22, and at least one workstation 24. The resources 18 are linked together over a conventional network 26 such as a local-area network or a wide-area network.

The inpatient database 20 includes a database management system for allowing a user to enter, organize, and select data contained within the database. Accordingly, the database 20 maintains a collection of inpatient information that is organized in a manner such that a user can select desired pieces of data contained therein. In an embodiment, the database 20 can be organized using hypertext whereby any object is linked to any other object. In yet another embodiment, the database 18 is organized by fields, records, and files wherein a field is a single piece of information regarding a specific inpatient, a record is one complete set of fields regarding a specific inpatient, and a file is a collection of inpatient records.

As indicated previously, the inpatient pharmacy server 22 is linked to the database 20, the workstation 24, and, via network 16, the outpatient pharmacy system 14. The inpatient server 22 provides for managing the inpatient pharmacy network resources 18. Although only one server is shown in FIG. 1, it is to be understood that the inpatient pharmacy system 12 can include more than one server to perform dedicated tasks such as having a dedicated file server for maintaining the database 20 and a network server for managing network traffic.

The workstation 24 consists of a computer 28 having application software (not shown) for performing operations within inpatient pharmacy system 12, over network 26, and outpatient pharmacy system 14 over networks 16 and 42. Preferably, the computer 28 includes an output device comprising a display screen 30 and input devices comprising a keyboard and a mouse (not shown).

Similar to the inpatient pharmacy system 12, the outpatient pharmacy system 14 provides for maintaining pharmacy data, including records of outpatients. In an embodiment, the outpatient pharmacy system 14 is resident, at least in part, within an outpatient health care facility 32. Such outpatient healthcare facilities include a health center, clinic, department within a hospital, or other facility that provides walk-in, walk-out diagnostic and treatment services for people whose care does not require confinement or a hospital stay.

The outpatient pharmacy system 14 has a plurality of resources 34 comprising a database 36, a server 38, and at least one workstation 40. The resources 34 are linked together over a conventional network 42 such as a local-area network or a wide-area network.

The outpatient database 36 includes a database management system for allowing a user to enter, organize, and select data contained within the database. Accordingly, the database 36 maintains a collection of outpatient information that is organized such that a user can select desired pieces of data contained therein. In an embodiment, the database 36 can be organized using hypertext wherein any object is linked to any other object. In yet another embodiment, the database 36 is organized by fields, records, and files wherein a field is a single piece of information regarding a specific outpatient, a record is one complete set of fields regarding a specific outpatient, and a file is a collection of outpatient records.

As previously indicated, the outpatient pharmacy server 38 is linked to the database 36, the workstation 40, and, via network 16, the inpatient pharmacy system 12. The outpatient server 38 provides for managing the outpatient pharmacy network resources 34. Although only one outpatient server 38 is shown in FIG. 1, it is to be understood that the outpatient pharmacy system 14 can include more than one server to perform dedicated tasks such as having a dedicated file server for maintaining the database 36 and a network server for managing network traffic.

Like the inpatient pharmacy workstation 24, the outpatient pharmacy workstation 40 consists of a computer 44 having application software (not shown) for performing operations within outpatient pharmacy system 14, over network 42, and inpatient pharmacy system 12 over networks 16 and 26. Preferably, the computer 44 includes an output device comprising a display screen 46 and input devices comprising a keyboard and a mouse (not shown).

In FIG. 1, network 16 provides for linking together the inpatient pharmacy system 12 and the outpatient pharmacy system 14. The network 16 can consist of a local-area network, a wide-area network, a metropolitan-area network, or the Internet.

The system 10 allows a user of an inpatient pharmacy workstation 24 to access data within the inpatient database, and also access data within the outpatient database 36, via network 16 and the outpatient pharmacy server 38. Likewise, the system 10 allows a user of an outpatient pharmacy workstation 40 to access data within the outpatient database, and also access data within the inpatient database 20, via network 16 and the inpatient pharmacy server 22.

Once data is accessed from either, or both databases 20 and 36, the data can be manipulated and presented to the user in a selected format. Preferably, the workstations within the pharmacy systems 12,14 include graphical user interfaces with one or more windows, as described in detail further herein, that allow a user to execute programs for manipulating data and displaying the results thereof.

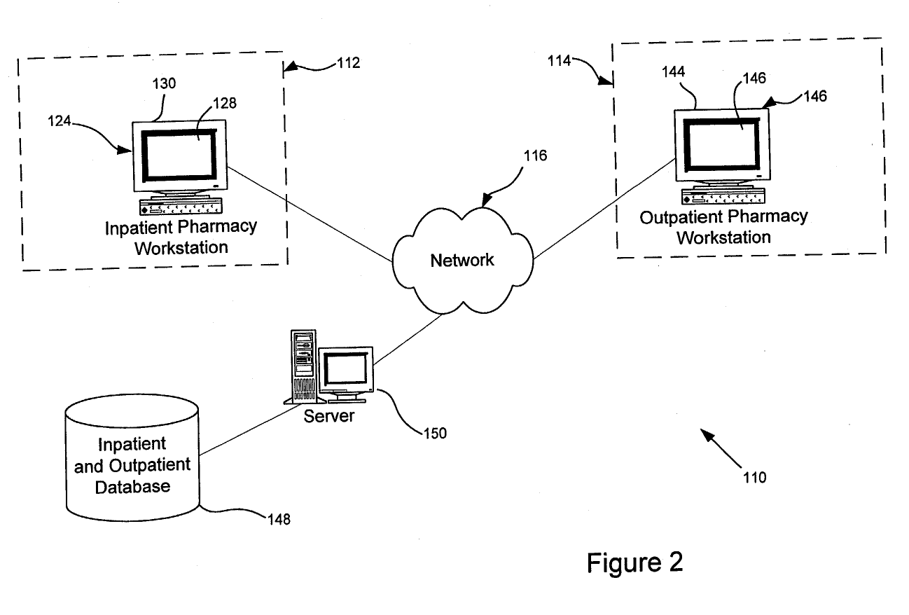

Turning to FIG. 2, a simplified schematic diagram is provided of another embodiment of a system 110 in accordance with the present invention. The system includes an inpatient pharmacy system 112 and an outpatient pharmacy system 114 in communication with a common database 148.

The inpatient pharmacy system 112 is resident, at least in part, within an inpatient healthcare facility 115 and includes at least one workstation 124 that is linked, via network 116, to the inpatient and outpatient database 148. Likewise, the outpatient pharmacy system 114 is resident, at least in part, within an outpatient healthcare facility 116 and includes at least one workstation 114 that is linked, via network 116, to the inpatient and outpatient database 148.

Database 148 includes a database management system for allowing a user to enter, organize, and select data contained within the database. Accordingly, the database 148 maintains a collection of inpatient and outpatient information that is organized such that a user can select desired pieces of data contained therein. In an embodiment, the database 148 can be organized using hypertext wherein any object is linked to any other object. In yet another embodiment, the database 148 is organized by fields, records, and fields wherein a field is a single piece of information regarding a specific inpatient or outpatient, a record is one complete set of fields regarding a specific inpatient or outpatient, and a file is a collection of inpatient or outpatient records.

As indicated previously, the inpatient pharmacy system 112 and the outpatient pharmacy system 114 are linked to the database 148, via network 116. In an embodiment, a server 150 is linked between the database 148 and the network 116 for providing management of the database 148.

The workstations 124 and 146 within the pharmacy systems 112 and 114, respectively, consist of a computer 128,146 having an output device comprising a display screen 130,146 and input devices comprising a keyboard and a mouse (not shown). The workstations 124 and 146 have application software (not shown) and are linked to the database 148 for allowing a user to maintain pharmacy data, including records of inpatients and outpatients, within the database.

The network 116 linking the inpatient pharmacy system 112 and the outpatient pharmacy system 114 to the database 148 can consist of a local-area network, a wide-area network, a metropolitan-area network, or the Internet.

Like the system 10 of FIG. 1, the system 110 of FIG. 2 allows a user of an inpatient pharmacy workstation 124 to access both inpatient and outpatient data contained within database 148. Moreover, a user of an outpatient pharmacy workstation 146 can access both inpatient and outpatient data contained within database 148.

Once inpatient data, outpatient data, or both, are accessed from the database 148, the data can be manipulated and presented in a user selected format. Preferably, the workstations within the pharmacy systems 112,114 include graphical user interfaces with one or more windows, as described in detail further herein, that allow a user to execute programs for manipulating pharmacy data and displaying the results thereof.

To maintain data integrity, preferably, inpatient data entered from an inpatient pharmacy system workstation cannot be edited by a user at an outpatient pharmacy system workstation. Likewise, outpatient data entered from an outpatient pharmacy system workstation cannot be edited by a user at an inpatient pharmacy system workstation.

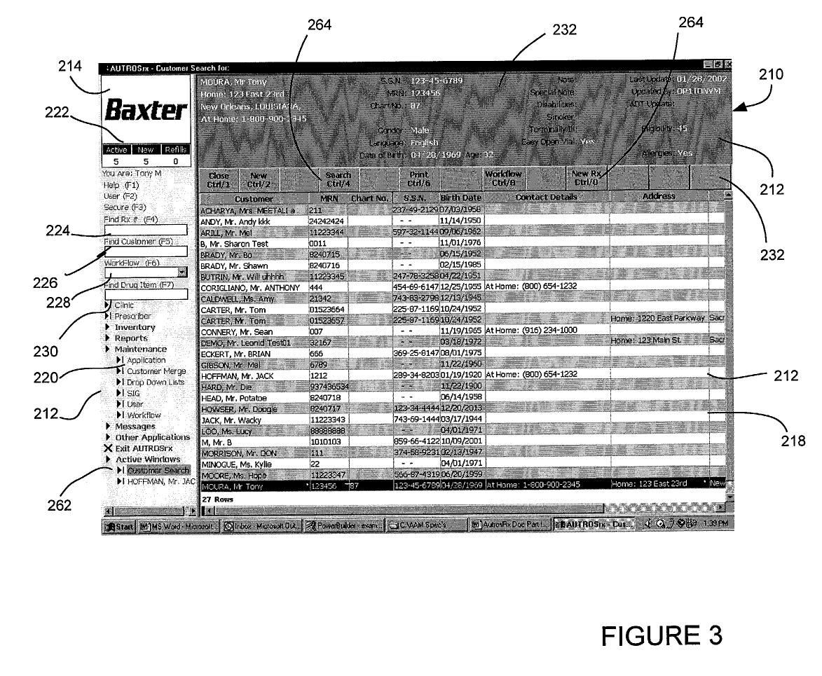

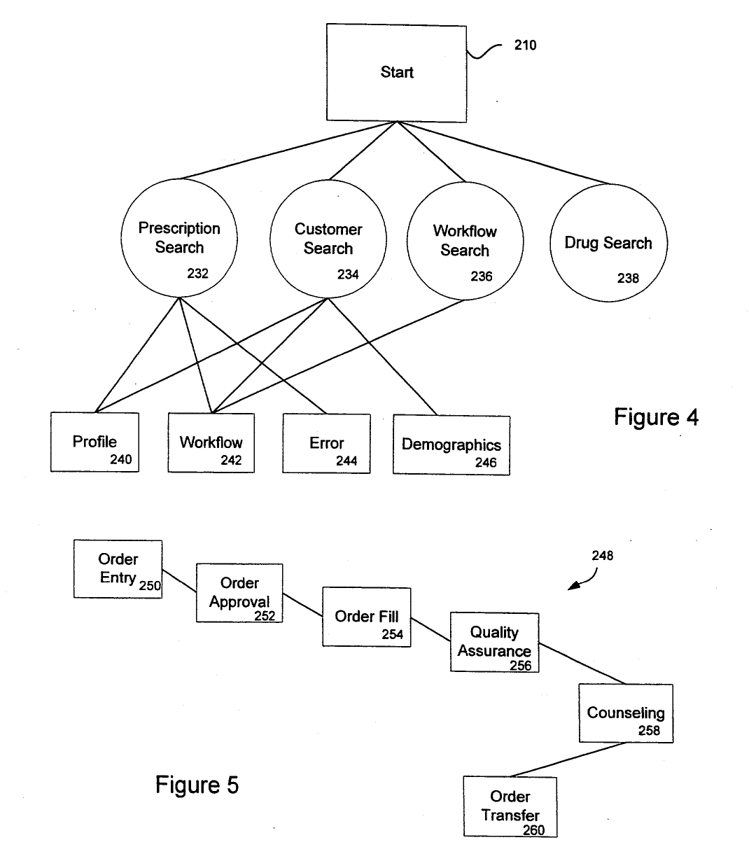

Turning to FIG. 3, a window 210 in accordance with the present invention is illustrated for display, via a graphical user interface, on the workstations within the pharmacy systems of FIGS. 1 and 2. Through the window 210, a user can access various data as shown, in part, by FIG. 4.

As depicted in FIG. 3, the window 210 includes a plurality of frames 212. In an embodiment, the frames 212 include a menu frame 214, a header frame 216, and a results frame 218.

Preferably, the menu frame 214 contains a list of folders 220 that are accessible to a user. The folders 220 within the menu 214 have a tree structure where folders and corresponding contents are identified to the user. Moreover, the menu 214 provides information such as a current logged user identifier, such as the user's name.

The menu frame 214 also contains an active pharmacy counter 222 for displaying the total number of pharmacy orders in the workflow, the total new prescriptions for the current date, and the total refill prescriptions for the current date. In an embodiment, the values within the active pharmacy counter 222 are updated when the window 210 is refreshed or over a predetermined period of time, such as three minutes, whichever occurs first.

The menu frame 214 further includes search request cells or fields for allowing a user to initiate a search request for a prescription 224, customer 226, workflow 228, or drug item 230. The user can enter data into the search field corresponding to the desired search, whereupon the search is conducted, or the user can push a function button on the keyboard to initiate additional search criteria windows 232 (FIG. 4) for conducting a search.

Preferably, the prescription number search request field 224 allows a user to enter a prescription number whereupon a search is conducted. Based upon the status of the prescription number entered, one of three popup windows (not shown) are displayed: customer profile 240, workflow 242, or error 244 as shown in FIG. 4. The customer profile window 240 is activated when the prescription number is valid and the prescription is not in the workflow. This window 240 displays the details of the prescription, when the prescription was last filled, and whether refills are permitted.

The workflow window 242 is activated when the prescription is in the workflow. This window 242 displays both the current status and the history of the prescription.

The error window 244 is displayed when the requested prescription number is invalid. This window 244 notifies the user of the error.

The customer search request field 226, depicted in FIG. 3, allows a user to enter customer information, such as last name, wherein a search is conducted based on the entered data. If any customers satisfy the search criteria, then the results are displayed in the results frame 218. The user then can select from any of the customers in the results frame, whereupon one of three popup windows (not shown) are displayed: customer demographic 246, workflow 242, or profile 240 as depicted in FIG. 4.

Preferably, the customer demographic window 246 is activated when the selected customer does not have any prescriptions. The customer demographic window 246 displays personal information regarding the customer, such as full name, address, date of birth, telephone number, and allergies.

As previously indicated, the workflow window 242 is activated when the customer has prescriptions in the workflow. When activated, the window 242 displays both the current status of all prescriptions and their history.

As also previously indicated, the profile window 240 is activated when the customer has prescriptions and all prescriptions have been transferred to the customer. When activated, the window 240 displays details of all prescriptions, when the prescriptions were last filled, and whether refills are permitted.

The workflow search request field 228, depicted in FIG. 3, allows a user to enter a prescription number or other information regarding a prescription and, as a result, the user is presented with a workflow status window 242 containing information regarding where a prescription is in the workflow process.

Turning to FIG. 5, the workflow process lists, via prompts, the discreet steps normally used in a facility, such as a pharmacy, to process prescriptions. As will be appreciated by those having skill in the art, a number of these steps can be combined to facilitate the work environment.

Once a user, such as a pharmacy staff member, enters the workflow 242 (FIG. 4), the user can execute the steps sequentially or workstations can be assigned specific functions in a production or assembly line environment. In a production mode, the prescription is processed at one station and when completed it is moved to the next station. The production mode is well suited for high volume prescription processing in retail, mail order, and central fill environments. Retail facilities use a combination of these two types of processes to dispense prescriptions. The use of bar coding has inherent efficiencies by reducing keystrokes and refreshing screens based on the current status of the transaction.

It is to be understood that a prescription is in the workflow when it is active (i.e., not cancelled) and the prescription has not been transferred to the customer. The transfer takes place when the prescription is delivered to, or picked up by, the customer.

As indicated above, a workflow process path is facility dependent. In an embodiment, the system automatically designates the next workflow process step. The user can overwrite the contents of the workflow status window 242 during data entry and throughout the workflow processes. Moreover, the user can override any default values. The workflow status is updated when the user has completed a predefined process.

In an embodiment, an algorithm used by the system to calculate the appropriate workflow process can include: stopping or holding the process whenever mandatory information is missing; stopping or holding the process whenever new prescription fill data has not been entered and the facility or pharmacy has a mandated approval process for new prescriptions; requesting that the doctor be called when the number of refills regarding a prescription is zero, or the prescription has expired; automated filling of the order; flagging the order if it is a special order; processing the order through quality assurance; counseling the patient regarding use of the prescription; and indicating that the order has been picked up or delivered.

In an embodiment, the workflow process further requires an approval step 252. This step can be performed by a pharmacist to validate the data entry step 250 for a first fill against the written prescription. This step 252 provides confirmation that the data entry for the new prescription was entered correctly and to provide for the application of any corrections before the prescription label is printed and also prior to the fill step 254.

Preferably, after the approval step 252, the order is filled 254 if there are not exceptions during the data entry step. As will be appreciated by those having skill in the art, there are a number of possible manual and automated fill processes which are facility or pharmacy dependent.

After the order is filled by conventional means, the order is processed though a quality assurance step 256 wherein the filled order is checked for accuracy against the prescription or other criteria consistent with the healthcare facility's policies and procedures. Preferably, the quality assurance step 256 is performed by a pharmacist. The quality assurance step 256 can be performed at a dedicated workstation, or alternatively, the pharmacist can move to the area where the prescription was filled.

Following the quality assurance step 256 are the patient counseling step 258 and the order transfer step 260. The patient counseling step 258 can consist of informing the patient about how the prescription is to be used. Further, the order transfer step 260 can consist of delivery of the order to the patient.

In an embodiment, there are a number of events that may not be defined as workflow process, but are preferably recorded by the pharmacy system as activities in the workflow history, including: on-line claims adjudication, medical/clinical check, print label, and print monograph.

In an embodiment, the workflow process includes formal review and approval by a pharmacist to ensure that work performed by any non-pharmacist is checked for accuracy and compliance with professional and legal standards. Preferably, this approval process is logged within the database and thus available for future reference.

Turning back to FIG. 3, the drug item field 230 allows a user to enter the name of a drug, whereupon a search is conducted and all items satisfying the search criteria are displayed within the results frame 218. The user can then select any of the search results, whereupon information regarding the selected item is displayed in the results frame 218. The information for the selected item can include specific details, equivalents to the selected item, prescriptions, images (i.e., photographs of the selected item) and other related information. In an embodiment, detail information can include generic name, trade name, short name, package information, classification, parameters, hazard warnings, and other like information. The prescription information can include a list of all patients taking the selected item, along with the prescriber, date entered, quantity, prescription number, and other related information.

In an embodiment, the system provides for parking one or more windows. Parking refers to the currently active window being temporarily minimized in order to allow the user to attend to another related or unrelated function. For example, when a user is entering or editing a prescription when the phone rings, the user can proceed to initiate a customer query without losing the current active window.

In an embodiment, the system supports a maximum of nine concurrently parked 10 windows. The windows are listed in the menu frame 214 by a primary identifier 262. Preferably, primary identifiers include: by customer name for parked customer and master prescription windows; by workstation process for workflow windows; by prescriber name for prescriber windows; and by generic name for drug items.

In an embodiment, windows can be parked when one or more criteria are satisfied. Preferably, a window can be parked when the user specifically requests the window be parked and no conflicts exist as explained in detail further herein. A window can also be parked when the window is in the edit mode and the user responds affirmatively when requested by the system to park the window.

A conflict exists, and thus a window cannot be parked when parking the selected window would result in more than one window per customer, more than one window per prescriber, or more than one window for a workflow.

Preferably, common to the prescription window 250 (FIG. 5), customer window 240 (FIG. 4) and workflow window 242 (FIG. 4) is a billing payment coverage window (not shown) that can be accessed via a pushbutton or the like. The billing payment coverage window preferably lists pertinent information for online claims adjudication. If desired, credit card information can also be included where a facility requires prepayment.

In an embodiment, the billing payment coverage window includes three types of information: billing information such as cost, markup, dispensing fee, and the like; payment information pertaining to what bills have been submitted and what payments have been received; and coverage or insurance information normally required for claims adjudication.

For a selected prescription fill request, the billing payment coverage window lists the pertinent billing information. The billing information preferably is accessible for updates while the prescription is active in the workflow. Other times, however, it is desired that the window be “read only.”

Turning back to FIG. 3, the header frame 216 within window 210 includes a plurality of functions that can be selected by a user via pushbuttons 264. The function associated with each button 264 can be enabled or disabled depending on the constraints or rules of the active window 210. Moreover, some of the functions may provide the user with multiple secondary options.

Turning back to FIGS. 1 and 2, it is preferred that systems 10 and 110, respectively, include security checks and balances to ensure that the data contained within the pharmacy databases is secure. In an embodiment, each system depicted in FIGS. 1 and 2 only allows authorized users (i.e., those users having authorization) to gain system access and obtain information contained within the pharmacy database(s). Preferably, each authorized user must enter his or her personal ID and corresponding password before access is granted. Authorization can be granted by a system administrator or the like.

The workstations can also include other security measures to prevent unauthorized users from gaining access to privileged patient data through use of unattended workstations. In an embodiment, each workstation can log a user out of the system after a predetermined period of non-use. In a further embodiment, a user can cause a workstation to go into a hibernation mode or standby mode by pressing a function key or the like. When entering the hibernation mode, the workstation saves all information and provides a window on the workstation's display requesting that the user reenter his or her ID and password. Once reentered, the workstation returns on the display the same information that was present on the display when the user initially requested that the workstation enter the hibernation mode.

In an embodiment, the databases can maintain a log of events such as changes to data that relate to any patient. Preferably, the log includes the change made, identification of the user who made the change, and the date when the change was made.

While the specific embodiments have been illustrated and described, numerous modifications come to mind without significantly departing from the spirit of the invention and the scope of protection is only limited by the scope of the accompanying claims.

1. A system comprising:
an inpatient pharmacy having a workstation and an inpatient pharmacy database containing inpatient pharmacy information;
an outpatient pharmacy having a workstation and an outpatient pharmacy database containing outpatient pharmacy information;
an network connected between the inpatient pharmacy and the outpatient pharmacy; and,
the inpatient pharmacy workstation in communication with the outpatient pharmacy database over the network.

2. The system of claim 1 wherein the inpatient pharmacy information is displayed on a window provided on the outpatient pharmacy workstation.

3. The system of claim 1 wherein the outpatient pharmacy information is displayed on a window provided on the inpatient pharmacy workstation.

4. The system of claim 1 wherein the inpatient pharmacy system and outpatient pharmacy system have workstations with standardized graphical user interfaces.

5. The system of claim 1 wherein the inpatient pharmacy workstation includes an application for accessing the outpatient pharmacy database.

6. The system of claim 1 wherein the outpatient pharmacy workstation includes an application for accessing the inpatient pharmacy database.

7. The system of claim 1 wherein only authorized users can access data contained within the inpatient pharmacy database and the outpatient pharmacy database.

8. The system of claim 1 wherein information contained within the inpatient pharmacy database and the outpatient pharmacy database is displayed on a window.

9. The system of claim 8 wherein the window can be parked.

10. The system of claim 1 wherein an application is provided to at least one of the workstations for directing a user through a workflow process.

11. The system of claim 10 wherein the workflow process includes order entry and order fill.

12. The system of claim 1 wherein an application is provided to at least one of the workstations for displaying a billing payment coverage window for entry of bill payment information.

13. A system comprising:
an inpatient pharmacy having a workstation;
an outpatient pharmacy having a workstation;
a pharmacy database operably connected to the inpatient pharmacy and the outpatient pharmacy; and,
patient information contained within the pharmacy database.

14. The system of claim 13 wherein the pharmacy database contains both inpatient pharmacy information and outpatient pharmacy information.

15. The system of claim 14 wherein the inpatient pharmacy workstation includes an application for accessing the outpatient pharmacy information.

16. The system of claim 14 wherein the outpatient pharmacy workstation includes an application for accessing the inpatient pharmacy information.

17. The system of claim 13 wherein only authorized users can access data contained within the pharmacy database.

18. The system of claim 13 wherein the patient information contained within the pharmacy database is displayed on a window.

19. The system of claim 18 wherein the window can be parked.

20. The system of claim 13 wherein an application is provided to at least one of the workstations for directing a user through a workflow process.

21. The system of claim 20 wherein the workflow process includes order entry and order fill.

22. The system of claim 21 wherein an application is provided to at least one of the workstations for displaying a billing payment coverage window for entry of bill payment information.

23. A method comprising the step of:
providing an application on a workstation within an inpatient pharmacy;
providing an application on a workstation within an outpatient pharmacy;
accessing patient information contained within a pharmacy database operably connected to the workstations within the inpatient pharmacy and the outpatient pharmacy.

24. The method of claim 23 further comprising the steps of providing security to prevent unauthorized users from accessing the patient information contained within the pharmacy database.

25. The method of claim 23 further comprising the step of displaying on a window the patient information contained within the pharmacy database.

26. The method of claim 25 further comprising the step of parking the window.

27. The method of claim 23 further comprising the step of directing a user through a workflow process for filling a prescription within the inpatient pharmacy.

28. The method of claim 23 further comprising the step of directing a user through a workflow process via a window on at least one of the workstations for filling a prescription within the outpatient pharmacy.

29. The method of claim 23 further comprising the step of displaying a billing payment coverage window on at least one of the workstations for entry of bill payment information.
